(19) United States
(12) Patent Application Publication
(10) Pub. No.: US 2026/0054361 A1
(43) Pub. Date: Feb. 26, 2026

(54) WORKING MACHINE

(71) Applicant: Koki Holdings Co., Ltd., Tokyo (JP)

(72) Inventors: Sotaro AIZAWA, Ibaraki (JP); Toshinori YASUTOMI, Ibaraki (JP); Toshiki OKABE, Ibaraki (JP); Yutaka ITO, Ibaraki (JP); Takeshi SAITOU, Ibaraki (JP); Hiroshi ICHINOHE, Ibaraki (JP); Kazuya KIKKAWA, Ibaraki (JP); Naohiro MAKI, Ibaraki (JP)

(21) Appl. No.: 19/104,911

(22) PCT Filed: Jul. 28, 2023
(86) PCT No.: PCT/JP2023/027760

§ 371 Date: Feb. 19, 2025

(30) Foreign Application Priority Data
Aug. 31, 2022 (JP) 2022-137828

(51) Int. Cl. B25C 1/04; B25C 1/00; B25C 1/06

(52) U.S. Cl. CPC B25C 1/047; B25C 1/001; B25C 1/06

(57) ABSTRACT

A working machine includes a magazine that houses a plurality of fasteners inside, an ejection unit to which the fastener is supplied, and a driver blade that moves to a lower side in an up-down direction to strike the fastener supplied to the ejection unit. The working machine further includes a biasing unit that biases the driver blade to the lower side, a conversion mechanism that winds up the driver blade to the upper side in the up-down direction, and an electric motor that generates a driving force for driving the conversion mechanism. The magazine is provided at a position overlapping with the electric motor as viewed in a direction of a rotation axis of the electric motor.

### TECHNICAL FIELD

The present invention relates to a working machine.

### BACKGROUND ART

Patent Document 1 describes an electric nailing machine having a roll magazine that houses a plurality of fasteners in a roll shape.

### RELATED ART DOCUMENTS

### Patent Documents

Patent Document 1: International Publication No. WO2021/084993.

### SUMMARY OF THE INVENTION

### Problems to be Solved by the Invention

However, since the roll magazine has a large outer shape, the size of the entire working machine tends to increase in order to avoid interference of the roll magazine with the motor housing. The increase in size of the working machine leads to degradation of operability and workability for the worker. The degradation of operability and workability leads to degradation of usability of the working machine. Therefore, there is a demand for a working machine with improved usability to be provided.

### Mean for Solving the Problem

A working machine according to one embodiment includes: a magazine that houses a plurality of fasteners inside; an ejection unit to which the fastener is supplied; a striking unit that moves to one side in a first direction to strike the fastener supplied to the ejection unit; a biasing unit that biases the striking unit toward the one side in the first direction; a winding unit that winds up the striking unit toward the other side in the first direction against a biasing force of the biasing unit; and a motor that generates a driving force for driving the winding unit, and the magazine is provided at a position overlapping with the motor as viewed in a direction of a rotation axis of the motor.

A working machine according to another embodiment includes: a magazine that has a substantially cylindrical shape and houses a plurality of fasteners wound in a spiral shape inside; an ejection unit to which the fastener is supplied; a striking unit that moves to one side in a first direction to strike the fastener supplied to the ejection unit; a biasing unit that biases the striking unit toward the one side in the first direction; a winding unit that winds up the striking unit toward the other side in the first direction against a biasing force of the biasing unit; a motor that generates a driving force for driving the winding unit; a handle that is gripped by a worker; and a motor case that houses the motor, and the motor case is provided with a recess for avoiding interference with the magazine.

A working machine according to still another embodiment includes: a magazine that houses a plurality of fasteners inside; an ejection unit to which the fastener is supplied; a striking unit that moves to one side in a first direction to strike the fastener supplied to the ejection unit; a biasing unit that biases the striking unit toward the one side in the first direction; a winding unit that winds up the striking unit toward the other side in the first direction against a biasing force of the biasing unit by being rotated about a winding axis extending in a direction intersecting with the first direction; and a motor that generates a driving force for driving the winding unit, and the magazine is arranged on the winding axis.

### Effects of the Invention

According to the present invention, it is possible to provide a working machine with improved usability.

### BRIEF DESCRIPTIONS OF THE DRAWINGS

FIG. 1 is an external side view of a working machine according to a first embodiment of the present invention.

FIG. 2 is an internal cross-sectional view of a part of the working machine.

FIG. 3 is a top external view of the working machine.

FIG. 4 is an external view of a conversion mechanism and a striking mechanism included in the working machine.

FIG. 5 is a front external view of the working machine.

FIG. 6 is a rear external view of the working machine.

FIG. 7 is a side view illustrating an appearance on the opposite side of the appearance of the working machine illustrated in FIG. 1.

FIG. 8 is a rear external view of the working machine illustrated in FIG. 1 in a direction of a motor axis.

FIG. 9 is a cross-sectional view taken along line A-A in FIG. 3.

FIG. 10 is a right external view illustrating a structure of a side surface of a working machine according to a second embodiment of the present invention.

FIG. 11 is a top external view of the working machine illustrated in FIG. 10.

FIG. 12 is a front external view of the working machine illustrated in FIG. 10.

FIG. 13 is a left external view of the working machine illustrated in FIG. 10.

FIG. 14 is a rear external view of the working machine illustrated in FIG. 10.

FIG. 15 is a bottom external view of the working machine illustrated in FIG. 10.

FIG. 16 is a bottom external view illustrating a nail loading state of the working machine illustrated in FIG. 15.

FIG. 17 is a cross-sectional view taken along line B-B in FIG. 16.

FIG. 18 is a top external view illustrating a method for opening a magazine cover of the working machine illustrated in FIG. 15.

FIG. 19 is a bottom external view illustrating the method for opening the magazine cover of the working machine illustrated in FIG. 15.

FIG. 20 is a left external view illustrating the method for opening the magazine cover of the working machine illustrated in FIG. 15.

FIG. 21 is a cross-sectional view taken along line C-C in FIG. 20.

FIG. 22 is a left external view illustrating a nail loading method of the working machine illustrated in FIG. 15.

FIG. 23 is a cross-sectional view taken along line D-D in FIG. 22.

FIG. 24 is a cross-sectional view taken along line E-E in FIG. 22.

FIG. 25 is an internal cross-sectional view illustrating an air feeding path for air supplied from a fan to a solenoid of the working machine illustrated in FIG. 15.

FIG. 26 is an internal cross-sectional view illustrating an air feeding path for air exhausted from an air exhaust port of a cylinder to the solenoid of the working machine illustrated in FIG. 15.

FIG. 27 is a cross-sectional view illustrating an air exhaust state inside the cylinder of the working machine illustrated in FIG. 26.

### DETAILED DESCRIPTION OF PREFERRED EMBODIMENTS

A working machine according to an embodiment will be described with reference to the drawings.

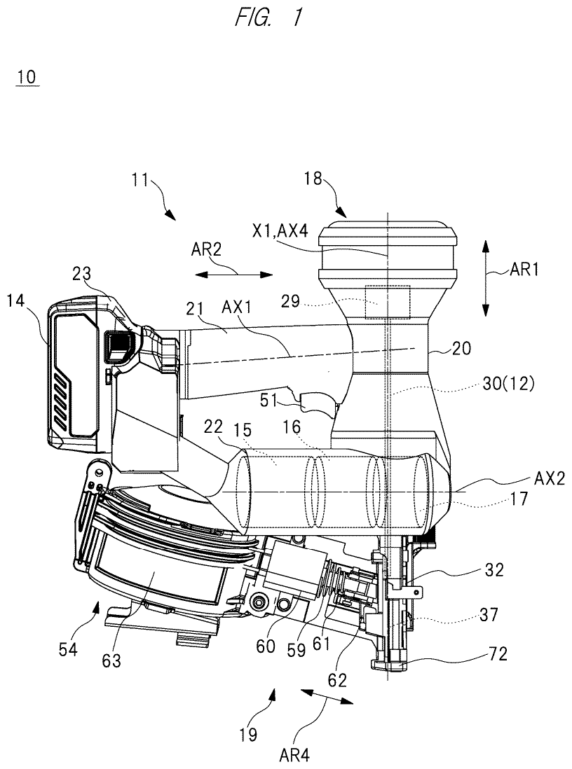

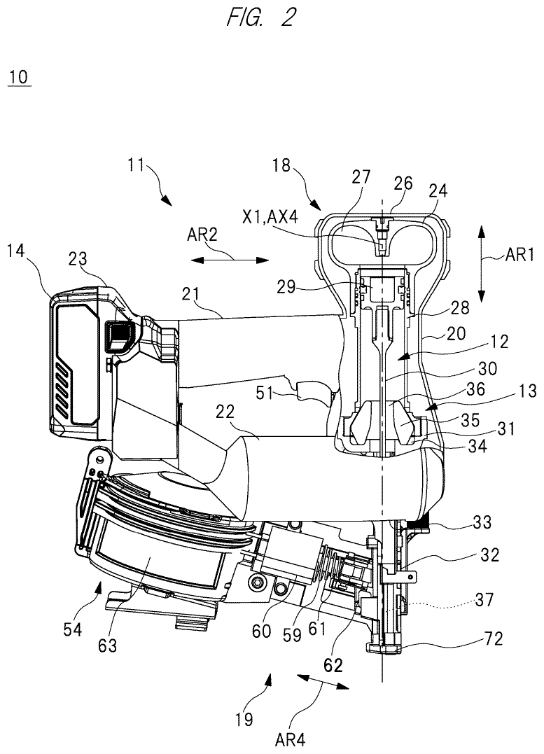

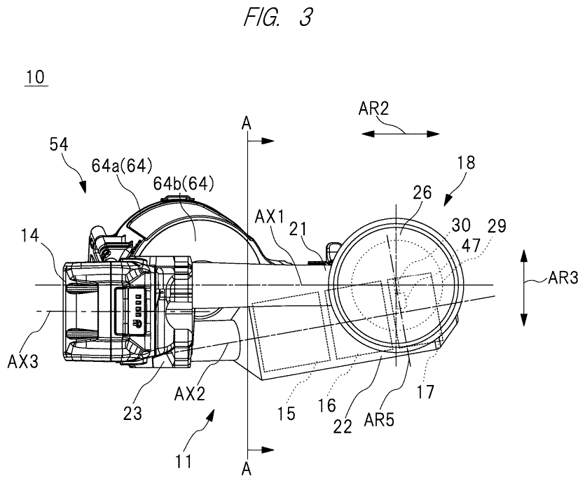

(First Embodiment) FIG. 1 is an external side view of a working machine 10 according to a first embodiment, and FIG. 2 is an internal cross-sectional view of a part of the working machine 10. FIG. 3 is a top external view of the working machine 10. The working machine 10 is, for example, an electric nailing machine, and includes a housing 11, a striking mechanism 12, a nose unit 13, a power supply unit 14, an electric motor 15, a gear case 16, a conversion mechanism 17, a pressure accumulation container 18, a supply mechanism 19, and a magazine 54.

Note that, in the following description, the upper part of the drawing sheet in FIGS. 1 and 2 may be referred to as an upper side, the lower part of the drawing sheet may be referred to as a lower side, the right side of the drawing sheet may be referred to as a front side, the left side of the drawing sheet may be referred to as a rear side, the near side of the drawing sheet may be referred to as a right side, and the far side of the drawing sheet may be referred to as a left side. In addition, the up-down direction may be referred to as a first direction AR1, the lower side may be referred to as one side in the first direction AR1, and the upper side may be referred to as the other side in the first direction AR1. In addition, the front-rear direction may be referred to as a second direction AR2, the front side may be referred to as one side in the second direction AR2, and the rear side may be referred to as the other side in the second direction AR2. In addition, as illustrated in FIG. 3, the right-left direction intersecting with the first direction AR1 and the second direction AR2 may be referred to as a third direction AR3, the right side may be referred to as one side in the third direction AR3, and the left side may be referred to as the other side in the third direction AR3.

<Housing 11> The housing 11 is an outline element of the working machine 10. The housing 11 includes a cylinder case 20, a handle 21 connected to the cylinder case 20, a motor case 22 connected to the cylinder case 20, and a battery attachment unit 23 connected to the handle 21 and the motor case 22.

<Cylinder Case 20> The cylinder case 20 supports a cylinder 28. The cylinder 28 is made of metal. The cylinder 28 is positioned with respect to the cylinder case 20 in a direction of a first center line X1 parallel to the first direction (up-down direction) AR1 and a radial direction (direction orthogonal to the first center line X1).

<Handle 21> As illustrated in FIG. 3, an axis AX1 of the handle 21 extends along the second direction (front-rear direction) AR2 of the working machine 10. That is, the axis AX1 of the handle 21 is parallel to the second direction AR2. It can also be said that the axis AX1 of the handle 21 extends in a direction intersecting with the first direction (up-down direction) AR1. As illustrated in FIGS. 1 and 2, a trigger 51 is provided on the lower side of the handle 21. A worker, that is, a user can operate the trigger 51 while holding the handle 21. A trigger switch (not illustrated) is provided in the handle 21, and outputs an operation signal when an operation force is applied to the trigger 51. When the operation force to the trigger 51 is released, the trigger switch stops outputting the operation signal.

<Motor Case 22> The motor case 22 is a housing unit that houses the electric motor 15, the gear case 16, and the conversion mechanism 17 described below. The motor case 22 has a tubular shape extending along a rotation axis AX2 of the electric motor 15. The rotation axis AX2 of the electric motor 15 extends in a direction intersecting with the first direction (up-down direction) AR1. As illustrated in FIG. 3, the motor case 22 (that is, the electric motor 15) is arranged on the right side (one side) of the handle 21 in the third direction (right-left direction) AR3. In addition, as viewed in the first direction (as viewed in the up-down direction), the rotation axis AX2 of the electric motor 15 is inclined with respect to the axis AX1 of the handle 21 on the right side (one side in the third direction AR3) of the handle 21. Specifically, the motor case 22 is inclined toward the axis AX1 of the handle 21 on the front side (one side) in the second direction AR2 in which the handle 21 extends. That is, the rotation axis AX2 of the electric motor 15 is inclined toward the axis AX1 of the handle 21 on the front side in the second direction AR2. Therefore, the rear end of the motor case 22 is located further on the right side of the handle 21 than the front end.

<Battery Attachment Unit 23> The battery attachment unit 23 is arranged at the rear end (that is, the other side in the second direction AR2) of the handle 21 and the motor case 22. The power supply unit 14 described below is detachably attached to the battery attachment unit 23. As illustrated in FIG. 3, a center axis AX3 of the battery attachment unit 23 is parallel to the axis AX1 of the handle 21, that is, the second direction AR2. Also, the center axis AX3 of the battery attachment unit 23 is arranged at a position shifted to one side (right side) in the third direction (right-left direction) AR3 with respect to the handle 21. Therefore, the battery attachment unit 23 is connected to the handle 21 on the left side of the front end surface, and is connected to the motor case 22 on the right side of the front end surface.

<Striking Mechanism 12> As illustrated in FIG. 2, the striking mechanism 12 includes a piston 29 and a driver blade 30. The piston 29 is provided on one side (lower side) in the first direction AR1 of the pressure accumulation container 18 described in detail below, and is continuously biased to one side (lower side) in the first direction AR1 by the pressure of a pressure chamber 27 provided in the pressure accumulation container 18. The piston 29 is movable along the first direction AR1 inside the cylinder 28. A seal member is attached to the outer peripheral surface of the piston 29. The seal member is in contact with the inner peripheral surface of the cylinder 28 to form a seal surface.

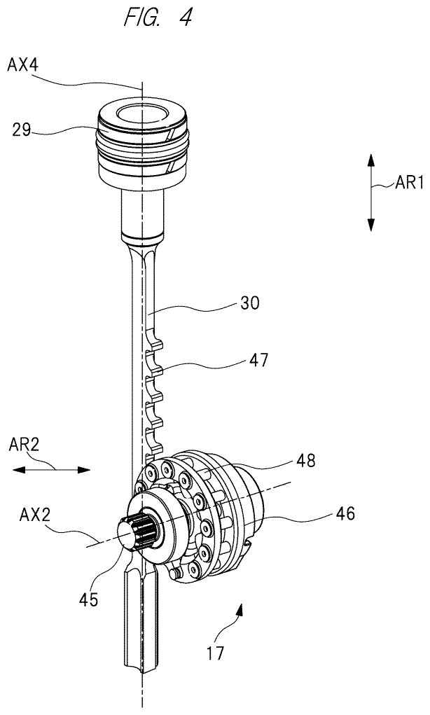

The driver blade 30 is made of, for example, metal. The driver blade 30 is connected to the piston 29 on the lower side of the piston 29 in the first direction AR1 and extends along the first center line X1. Since the piston 29 is movable in the first direction AR1 as described above, the driver blade 30 is also movable in the first direction AR1. That is, a striking axis AX4 of the striking mechanism 12 extends along the first direction AR1. On the driver blade 30, a plurality of racks 47 (see FIG. 4) are arranged at predetermined intervals along the first direction AR1, which is the moving direction. As illustrated in FIG. 3, the rack 47 protrudes toward the rotation axis AX2 of the electric motor 15 along a protruding direction AR5 from the driver blade 30. The protruding direction AR5 is a direction orthogonal to the rotation axis AX2 of the electric motor 15. As described above, since the rotation axis AX2 of the electric motor 15 is inclined with respect to the axis AX1 of the handle 21 as viewed in the first direction (as viewed in the up-down direction), the protruding direction AR5 intersects with the axis AX1 of the handle 21 at a non-right angle.

Note that the movement of the driver blade 30 toward one side (lower side) in the first direction AR1 in FIG. 1 is referred to as falling. The movement of the driver blade 30 toward the other side (upper side) in the first direction AR1 in FIG. 1 is referred to as rising.

<Nose Unit 13> The nose unit 13 is positioned and arranged in the direction of the first center line X1 and the radial direction of the cylinder 28 with respect to the cylinder case 20. The nose unit 13 includes a bumper support unit 31, an ejection unit 32, and a tubular unit 33. The bumper support unit 31 has a tubular shape and has a guide hole 34. The guide hole 34 is arranged to center on the first center line X1.

A bumper 35 is arranged in the bumper support unit 31. The bumper 35 is integrally molded using, for example, synthetic rubber such as elastomer. The bumper 35 is provided with a guide hole 36 centering on the first center line X1. The driver blade 30 is movable in the first direction AR1 inside the guide hole 36.

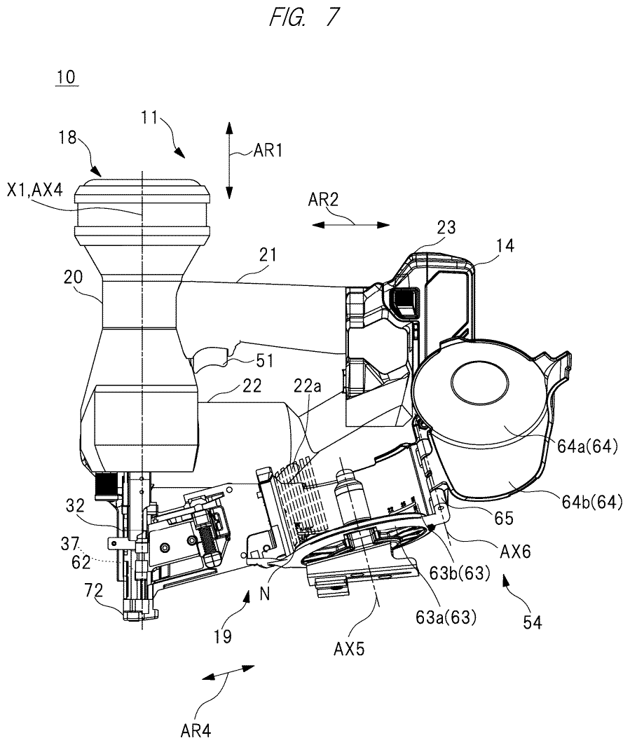

The ejection unit 32 is connected to the bumper support unit 31 and the tubular unit 33, and protrudes to the lower side in the first direction AR1 from the bumper support unit 31. The ejection unit 32 has an ejection path 37, and the ejection path 37 is concentrically provided to center on the first center line X1. The driver blade 30 is movable along the first direction AR1 inside the ejection path 37. A nail N (see FIG. 7), which is a fastener housed in the magazine 54 described below, is supplied to the ejection path 37 of the ejection unit 32.

A push lever 72 is attached to the lower end of the ejection unit 32 in the first direction AR1. The push lever 72 is movable within a predetermined range in the first direction AR1 with respect to the ejection unit 32.

<Power Supply Unit 14> The power supply unit 14 is a direct-current power supply that is detachably attached to the battery attachment unit 23 along the first direction AR1 and supplies power to the electric motor 15 and the supply mechanism 19. The power supply unit 14 includes a housing case and a plurality of battery cells housed in the housing case. The battery cell is a secondary battery capable of charging and discharging, and any one of a lithium ion battery, a nickel hydrogen battery, a lithium ion polymer battery, and a nickel cadmium battery can be used.

<Electric Motor 15> The electric motor 15 receives power supplied from the power supply unit 14 and rotates to drive the striking mechanism 12. The electric motor 15 is arranged in the motor case 22. The electric motor 15 is a brushless motor having a rotor and a stator. As illustrated in FIG. 1, the rotation axis AX2, which is the rotation center of the electric motor 15, is orthogonal to the first center line X1 as viewed in the right-left direction (third direction AR3).

<Gear Case 16> The gear case 16 is provided on the front side of the electric motor 15 in the motor case 22. The gear case 16 has a tubular shape and does not rotate with respect to the nose unit 13 and the tubular unit 33. A deceleration mechanism having an input element, an output element, and a plurality of sets of planetary gear mechanisms is provided in the gear case 16. The input element of the deceleration mechanism is connected to the rotation shaft of the electric motor 15, and the input element is rotatably supported by a bearing.

<Conversion Mechanism 17> FIG. 4 is an external view of the conversion mechanism 17, the piston 29, and the driver blade 30. The conversion mechanism 17 is provided on the front side of the gear case 16 in the motor case 22, and converts the rotational force of the output element of the deceleration mechanism in the gear case 16 into the moving force of the driver blade 30 in the first direction AR1. The conversion mechanism 17 includes a drive shaft 45, a pin wheel 46, and a pinion pin 48. The drive shaft 45 is rotatably supported by a bearing to center on the rotation axis AX2 of the electric motor 15. The pin wheel 46 is fixed to the drive shaft 45. The pin wheel 46 has a plurality of pinion pins 48.

The plurality of pinion pins 48 are arranged at intervals from each other in the rotation direction of the pin wheel 46. The plurality of pinion pins 48 are arranged in a range of a predetermined angle in the rotation direction of the pin wheel 46. The plurality of pinion pins 48 can be engaged with and disengaged from the plurality of racks 47 provided on the driver blade 30 described above in a one-to-one relationship.

When the pin wheel 46 rotates clockwise in FIG. 4 to engage at least one pinion pin 48 with at least one rack 47, the rotational force of the pin wheel 46 is transmitted to the driver blade 30 of the striking mechanism 12. The transmitted rotational force causes the driver blade 30 to move toward the other side (upper side) in the first direction AR1 against the pressure in the pressure chamber 27. That is, the conversion mechanism 17 functions as a winding unit that winds up the driver blade 30 toward the other side (upper side) in the first direction AR1 by being rotated by the driving force of the electric motor 15 in a state of being engaged with the driver blade 30.

When all the pinion pins 48 are released from the racks 47, the rotational force of the pin wheel 46 is not transmitted to the driver blade 30. As a result, the driver blade 30 descends due to the pressure in the pressure chamber 27 described below, and strikes the nail N supplied to the ejection unit 32. That is, the piston 29 and the driver blade 30 function as striking units that move to one side (lower side) in the first direction AR1 to strike the nail N which is a fastener supplied to the ejection unit 32. As a result, the nail N is struck by the driver blade 30 and driven into the workpiece (driven material).

<Pressure Accumulation Container 18> The pressure accumulation container 18 illustrated in FIG. 1 includes a cap 24. A head cover 26 is attached to the upper side of the cylinder case 20 in the first direction AR1, and the pressure accumulation container 18 is arranged in the cylinder case 20 and the head cover 26. The pressure chamber 27 is provided in the pressure accumulation container 18. The pressure chamber 27 is filled with gas. The gas may be any compressible gas. As the gas, air or an inert gas such as a nitrogen gas or a rare gas is used. As described above, the striking mechanism 12 is continuously biased to one side (lower side) in the first direction AR1 by the pressure in the pressure chamber 27 provided in the pressure accumulation container 18. That is, the pressure chamber 27 functions as a biasing unit that biases the striking mechanism 12 toward one side (lower side) in the first direction AR1. Note that description will be given, assuming that the pressure chamber 27 is filled with air.

<Supply Mechanism 19> The supply mechanism 19 supplies the nail N housed in the magazine 54 described below into the ejection unit 32 along a fourth direction AR4. The fourth direction AR4 is a direction that intersects with the first direction AR1 and is not parallel to the rotation axis AX2 (that is, the second direction AR2) of the electric motor 15.

The supply mechanism 19 includes a spring 59, a solenoid 60, an iron core 61, and a feeder unit 62. The feeder unit 62 can reciprocate along the fourth direction AR4 together with the iron core 61. The feeder unit 62 is provided with a plurality of feeding claws (not illustrated) at predetermined intervals along the fourth direction AR4.

The solenoid 60 includes a bobbin, a coil provided in the bobbin, and the like. The iron core 61 can reciprocate along the fourth direction AR4 with respect to the bobbin of the solenoid 60. The iron core 61 is made of, for example, a magnetic material such as iron. The spring 59 is a biasing member that biases the iron core 61 toward the front side in the fourth direction AR4, and positions the feeder unit 62 at an initial position. The coil of the solenoid 60 is connected to the power supply unit 14, and generates a magnetic attraction force when current is supplied by the power supply unit 14. Due to this magnetic attraction force, the iron core 61 moves to the rear side in the fourth direction AR4 against the biasing force of the spring 59. Along with the movement of the iron core 61, the feeder unit 62 also moves to a predetermined position (nail attachment position) on the rear side in the fourth direction AR4.

At the time of starting this movement, the feeding claw provided in the feeder unit 62 does not enter a space between the plurality of nails N connected by a connecting element described below. Therefore, the plurality of nails N are not moved to the front side in the fourth direction AR4. When the feeder unit 62 reaches the nail attachment position, the feeding claw provided in the feeder unit 62 enters the space between the nails N connected by the connecting element.

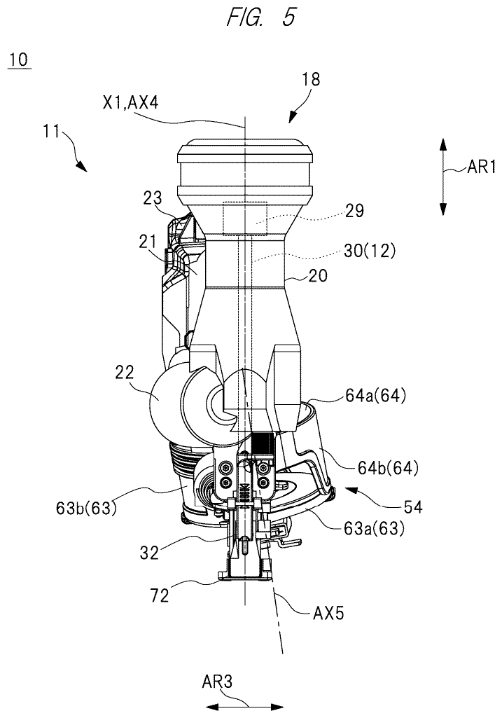

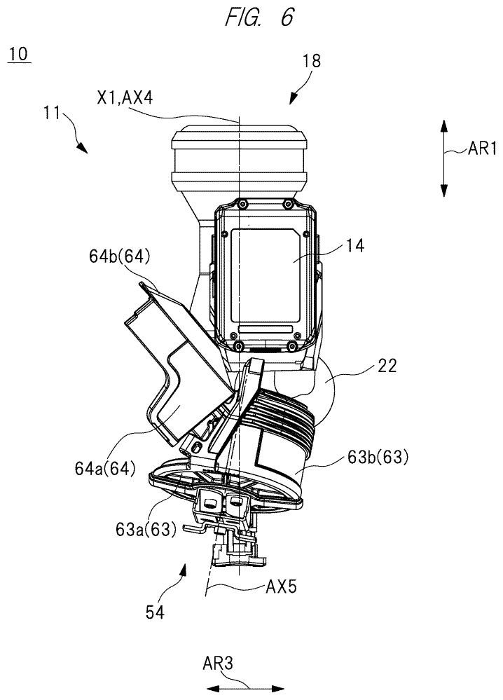

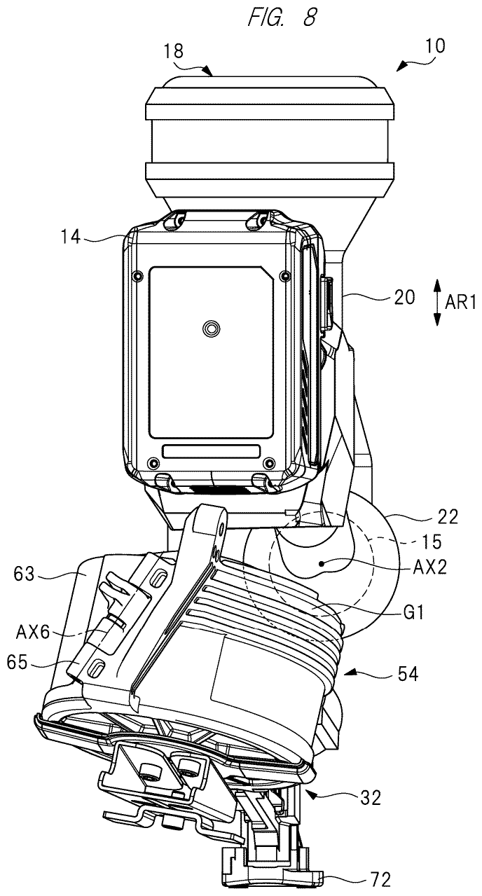

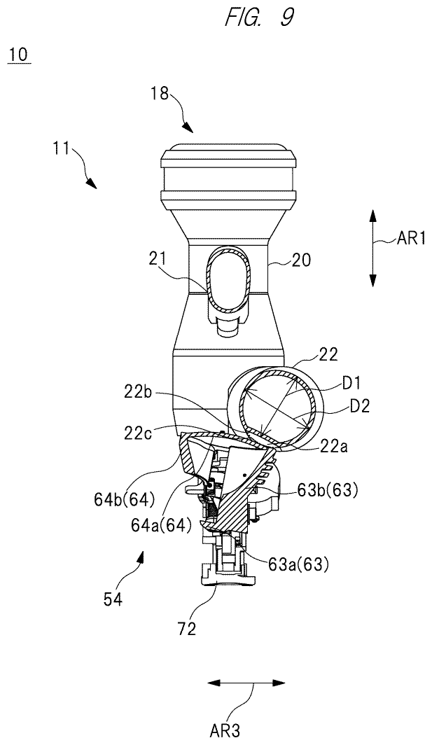

When the current supply by the power supply unit 14 is terminated, the coil eliminates the magnetic attraction force. As a result, the iron core 61 moves to the front side in the fourth direction AR4 due to the biasing force of the spring 59. Along with the movement of the iron core 61, the feeder unit 62 also moves from the nail attachment position to the front side in the fourth direction AR4 and moves to the initial position. When the feeder unit 62 moves to the front side in the fourth direction AR4, the nail N is supplied to the ejection unit 32 on the front side in the fourth direction AR4 by the feeding claw that moves together with the feeder unit 62. Thus, the feeder unit 62 positions the nail N, which is located at the head of the connecting element among the nails N housed in the magazine 54, to the lower side of the driver blade 30.

<Magazine 54> FIG. 5 is a front external view of the working machine 10, and FIG. 6 is a rear external view of the working machine 10. FIG. 7 is an external view of the left side of the working machine 10, FIG. 8 is a rear external view of the working machine 10 in the direction of the motor axis, and FIG. 9 is a cross-sectional view taken along line A-A in FIG. 3. The magazine 54 is supported by the supply mechanism 19. The magazine 54 has a substantially cylindrical shape centering on an axis AX5, and has a flat shape in which the diameter centering on the axis AX5 is larger than the size in the direction of the axis AX5. As illustrated in FIG. 3, the magazine 54 is arranged on one side (lower side) in the first direction (up-down direction) AR1 and on the rear side of the supply mechanism 19 (the other side in the second direction AR2) with respect to the handle 21 and the motor case 22 (that is, the electric motor 15). Also, as illustrated in FIGS. 5 and 6, the magazine 54 is arranged in a state where the axis AX5 is inclined with respect to the first direction (up-down direction) AR1, that is, the striking axis AX4 of the striking mechanism 12. Specifically, the axis AX5 of the magazine 54 is inclined toward the rotation axis AX2 of the electric motor 15 on the other side (upper side) in the first direction AR1. That is, the axis AX5 of the magazine 54 is inclined in a direction in which the upper end of the magazine 54 is headed further to the rotation axis AX2 of the electric motor 15 than the lower end of the magazine 54.

The magazine 54 has a drum unit 63 and a magazine cover 64, and houses therein the nails N, which are a plurality of fasteners connected to each other, in a roll shape. The plurality of nails N are connected to each other by the connecting element such as an adhesive and a wire, and each nail N extends to be parallel to the axis AX5. The plurality of connected nails N are arranged in the drum unit 63 in a spiral state, that is, in a rolled state, of being wound around the axis AX5.

The drum unit 63 is hollow and has a circular plate-shaped bottom surface 63a formed on the lower side and a side surface 63b erecting upward from the right side edge of the bottom surface 63a. In other words, an opening provided with no drum unit 63 is formed on the upper side and the left side of the magazine 54. Through this opening, the plurality of connected nails N are supplied to the inside of the drum unit 63. The plurality of supplied nails N are supported by the bottom surface 63a and the side surface 63b and housed in the drum unit 63. That is, the drum unit 63 functions as a housing unit that houses a plurality of fasteners.

The front end of the side surface 63b of the drum unit 63 is connected to the supply mechanism 19 and fixed to the housing 11. The rear end of the side surface 63b of the drum unit 63 is coupled with the magazine cover 64 described below.

The magazine cover 64 covers the opening of the magazine 54 provided with no drum unit 63, and is openably attached to the drum unit 63. Specifically, the magazine cover 64 has an upper surface 64a and a side surface 64b erecting downward from the left side edge of the upper surface 64a. The rear end of the side surface 64b of the magazine cover 64 and the rear end of the side surface 63b of the drum unit 63 are coupled by a coupling mechanism 65 such as a hinge.

A rotation axis AX6 of the coupling mechanism 65 is in a direction parallel to the axis AX5 of the magazine 54. This coupling mechanism 65 causes the magazine cover 64 to be rotated (that is, opened and closed) with respect to the drum unit 63 fixed to the housing 11 around the rotation axis AX6. FIGS. 5 and 7 each illustrate a state in which the magazine cover 64 is open. In this state, a plurality of fasteners are supplied in the drum unit 63 as described above. When the magazine cover 64 is in the open state, as illustrated in FIGS. 5 and 7, the magazine cover 64 is located on the rear side and the upper side of the drum unit 63 of the magazine 54. As described above, the center axis AX3 of the battery attachment unit 23 arranged at the rear end of the handle 21 is shifted in the right direction with respect to the axis AX1 of the handle 21, so that the magazine cover 64 in the open state is prevented from interfering with the battery attachment unit 23.

In the working machine 10 of the first embodiment, as illustrated in FIG. 8, the magazine 54 is provided at a position overlapping with the electric motor 15 as viewed in the direction of the rotation axis AX2 of the electric motor 15. Specifically, the drum unit 63 of the magazine 54 is provided at a position overlapping with the electric motor 15 as viewed in the direction of the rotation axis AX2 of the electric motor 15 (overlapping portion G1 in FIG. 8). That is, the drum unit 63 of the magazine 54 in the front-rear direction (second direction AR2) illustrated in FIG. 1 is arranged further on the rear side than the electric motor 15, and the drum unit 63 of the magazine 54 in the right-left direction (third direction AR3) illustrated in FIG. 6 is arranged further on the left side than the electric motor 15 (see FIG. 1). At this time, the drum unit 63 of the magazine 54 is arranged at a position overlapping with the electric motor 15 as viewed in the direction of the rotation axis AX2 of the electric motor 15. That is, the drum unit 63 of the magazine 54 is shifted to the rear side and the left side of the electric motor 15 to such an extent that the drum unit 63 is arranged at a position overlapping with the electric motor 15 as viewed in the direction of the rotation axis AX2 of the electric motor 15.

Further, FIGS. 1, 2, 3, and 9 illustrate a state in which the magazine cover 64 is closed. By closing the magazine cover 64, it is possible to prevent the plurality of fasteners housed in the drum unit 63 from falling off to the outside.

As described above, the motor case 22 has a tubular shape, and a recess 22a is provided in a part of the motor case 22 as illustrated in FIGS. 7 and 9. The recess 22a is formed on the lower rear side of the motor case 22, that is, at a position facing the upper surface 64a of the magazine cover 64 when the magazine cover 64 is in a closed state. The upper surface 64a of the magazine cover 64 is formed to have an arc shape around the axis AX5 of the magazine 54 so as to protrude toward the motor case 22, and a wall surface 22b of the recess 22a is formed to have an arc shape so as to be recessed in a direction away from the magazine cover 64. An outside diameter D1 of the motor case 22 in the region where the recess 22a is formed is smaller than an outside diameter D2 in the other region of the motor case 22 (see FIG. 9). Therefore, a problem that the magazine cover 64 cannot be closed due to interference between the magazine cover 64 and the motor case 22 is prevented from occurring. That is, the motor case 22 is provided with the recess 22a for avoiding the interference with the magazine cover 64. The recess 22a enables the motor case 22 and the magazine cover 64 to be arranged close to each other, and a virtual circle 22c coaxial with the motor case 22 and having a diameter equal to the outside diameter D2 comes into contact with the magazine cover 64.

Instead of the recess 22a formed in the motor case 22, a recess for avoiding the interference with the motor case 22 may be formed in the magazine cover 64 or the drum unit 63. The recess in this case is formed on the upper surface 64a of the magazine cover 64 at a position facing the motor case 22 when the magazine cover 64 is in the closed state. As a result, similar effects to those in the case where the recess 22a is formed in the motor case 22 can be obtained. Further, the recess 22a may be a hole or the drum unit 63 and the motor case 22 may be formed as an integrated component.

According to the embodiment described above, the following effects can be obtained.
(1) The drum unit 63 of the magazine 54 in the front-rear direction (second direction AR2) is arranged further on the rear side than the electric motor 15, the drum unit 63 of the magazine 54 in the right-left direction (third direction AR3) is arranged further on the left side than the electric motor 15, and the drum unit 63 of the magazine 54 is provided at a position overlapping with the electric motor 15 as viewed in the direction of the rotation axis AX2 of the electric motor 15. Therefore, the length of the working machine 10 in the up-down direction (first direction AR1) and the right-left direction (third direction AR3) can be shortened, and the working machine 10 can be reduced in size. As a result, degradation of operability and workability of the working machine 10 can be reduced, and usability of the working machine 10 can be improved.
(2) As viewed in the first direction, the axis AX1 of the handle 21 gripped by the worker extends along the second direction AR2 inclined with respect to the rotation axis AX2 of the electric motor 15. Therefore, the length of the working machine 10 along the second direction AR2 can be shortened as compared with a working machine in which the axis AX1 of the handle 21 and the rotation axis AX2 of the electric motor 15 are arranged in parallel. As a result, size reduction of the working machine 10 is achieved, and the worker can easily handle the working machine 10, so that workability can be improved.
(3) As viewed in the second direction, the axis AX5 of the magazine 54 is inclined with respect to the striking axis AX4 of the striking mechanism 12 extending in the first direction AR1. Therefore, the length of the working machine 10 along the first direction AR1 can be shortened as compared with a working machine in which the axis AX5 of the magazine 54 and the striking axis AX4 of the striking mechanism 12 are arranged in parallel. As a result, size reduction of the working machine 10 is achieved, and the worker can easily handle the working machine 10, so that workability can be improved.
(4) The magazine 54 is arranged on one side (lower side) in the first direction (up-down direction) AR1 with respect to the handle 21 and the electric motor 15, and the axis AX5 of the magazine 54 is inclined toward the rotation axis AX2 of the electric motor 15 on the other side (upper side) in the first direction AR1. The electric motor 15 is arranged on one side (right side) in the third direction with respect to the handle 21, and the rotation axis AX2 of the electric motor 15 is inclined toward the axis AX1 of the handle 21 on one side (front side) in the second direction AR2. Therefore, since the upper right part of the magazine 54 is located further on the lower side than the upper left part, the magazine 54 is prevented from interfering with the motor case 22 arranged on the right side of the handle 21. Also, the magazine 54 can be arranged further on the upper side in the first direction AR1 in a state where interference between the magazine 54 and the motor case 22 is avoided than in a case where the axis AX5 of the magazine 54 is parallel to the first direction AR1 (that is, the striking axis AX4 of the striking mechanism 12). As a result, size reduction of the working machine 10 in the right-left direction and the up-down direction can be achieved, and the worker can easily handle the working machine 10, so that workability can be improved.
(5) The battery attachment unit 23 is arranged at an end of the handle 21 on the other (rear) side in the second direction AR2. As viewed in the first direction, the center axis AX3 of the battery attachment unit 23 is arranged to be shifted to one side (right side) in the third direction AR3 with respect to the axis AX1 of the handle 21. Therefore, the amount of protrusion of the battery attachment unit 23 to the left side of the handle 21 can be reduced as compared with a case where the battery attachment unit 23 is arranged such that the center axis AX3 of the battery attachment unit 23 is along the axis AX1 of the handle 21. As a result, size reduction of the working machine 10 in the right-left direction can be achieved, and the worker can easily handle the working machine 10, so that workability can be improved. Further, when the magazine cover 64 of the magazine 54 is in an open state, the interference between the magazine cover 64 and the battery attachment unit 23 can be reduced.
(6) The motor case 22 is provided with the recess 22a that avoids interference with the magazine cover 64. Therefore, a problem that the magazine cover 64 cannot be closed due to interference between the magazine cover 64 and the motor case 22 is prevented from occurring.

The above-described embodiment can be modified as follows.

<Modification> The center axis AX3 of the battery attachment unit 23 is not limited to the one that is parallel to the axis AX1 of the handle 21, that is, the second direction AR2. For example, the center axis AX3 of the battery attachment unit 23 may be parallel to the rotation axis AX2 of the electric motor 15, that is, non-parallel to the second direction AR2. In this case, the lengths of the battery attachment unit 23 and the power supply unit 14 attached to the battery attachment unit 23 along the second direction AR2 are shorter than those when the center axis AX3 of the battery attachment unit 23 is parallel to the second direction AR2. That is, the entire length of the working machine 10 along the second direction AR2 can be shortened. As a result, the worker can easily handle the working machine 10, so that workability at the time of using the working machine 10 is improved. Further, in the modification as well, when the magazine cover 64 of the magazine 54 is in an open state, the interference between the magazine cover 64 and the battery attachment unit 23 can be reduced.

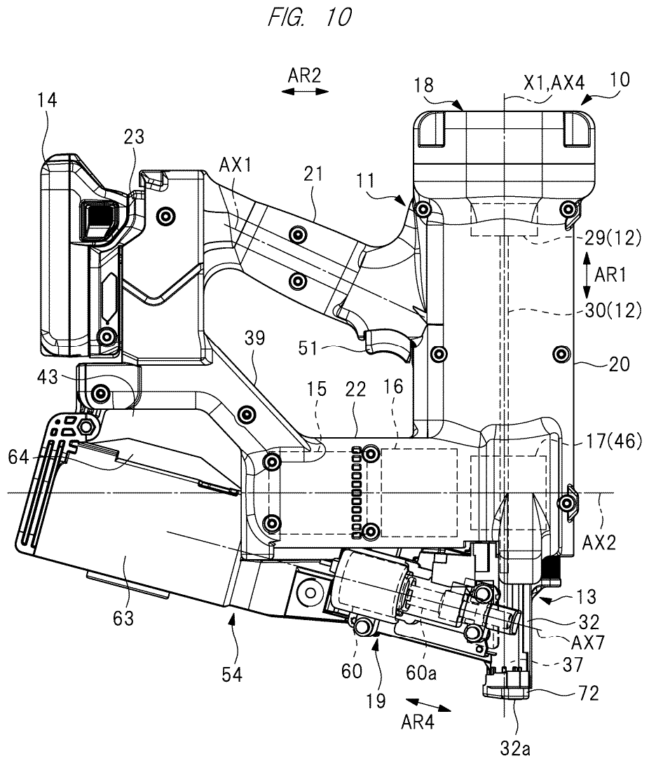

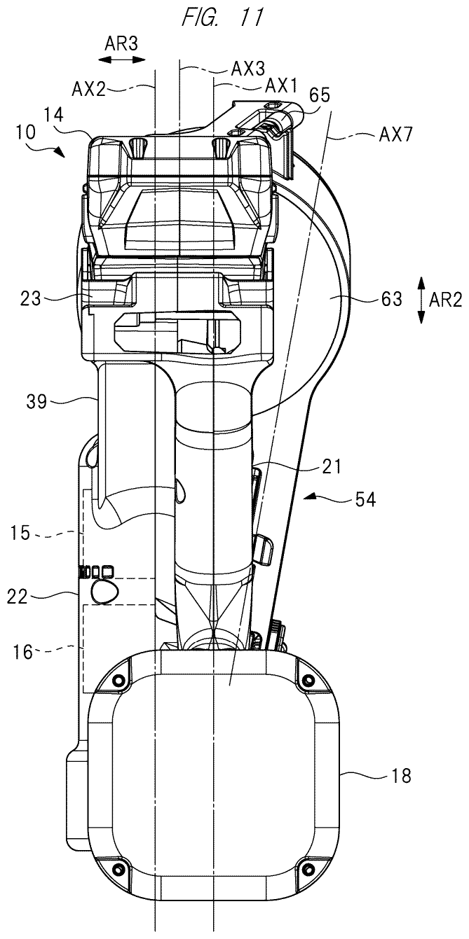

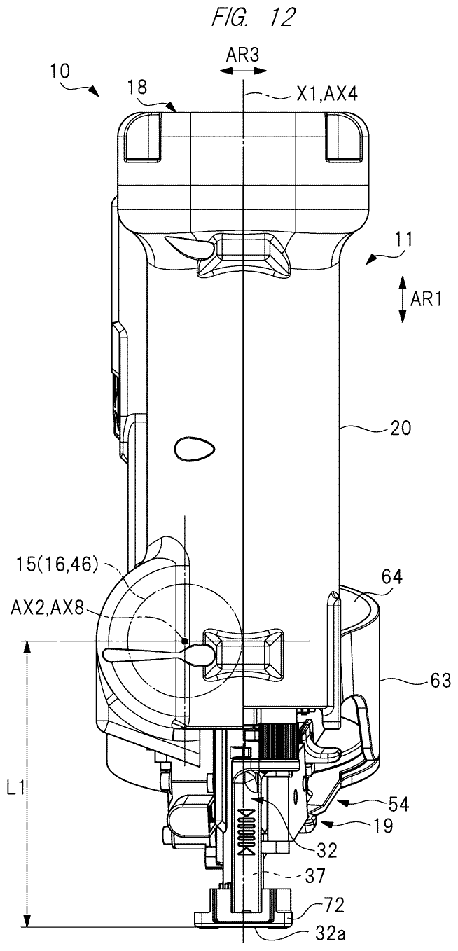

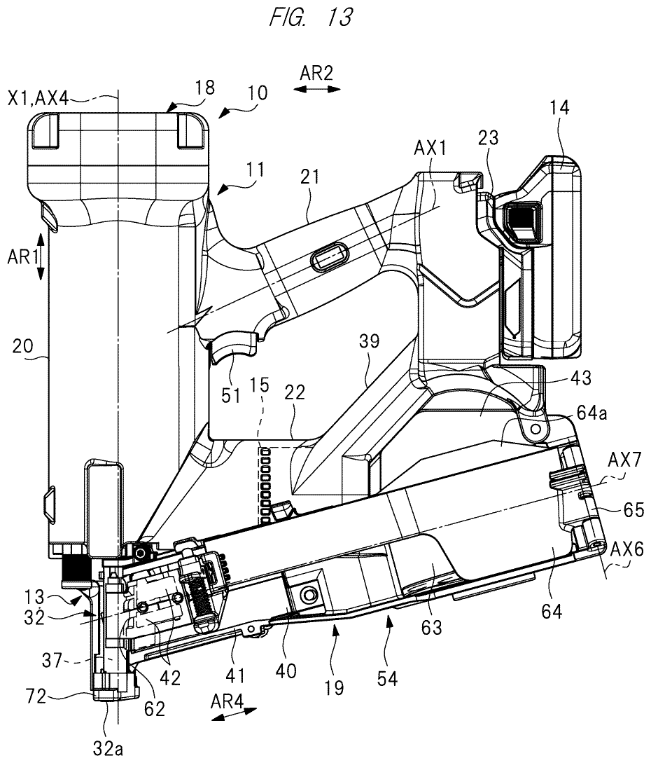

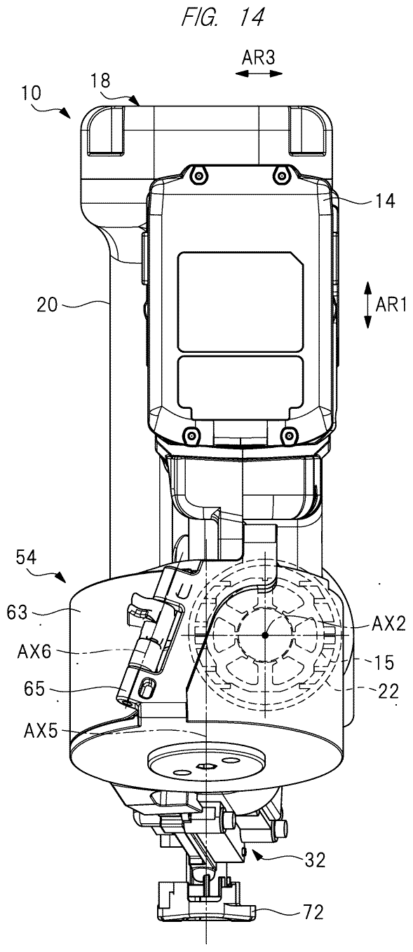

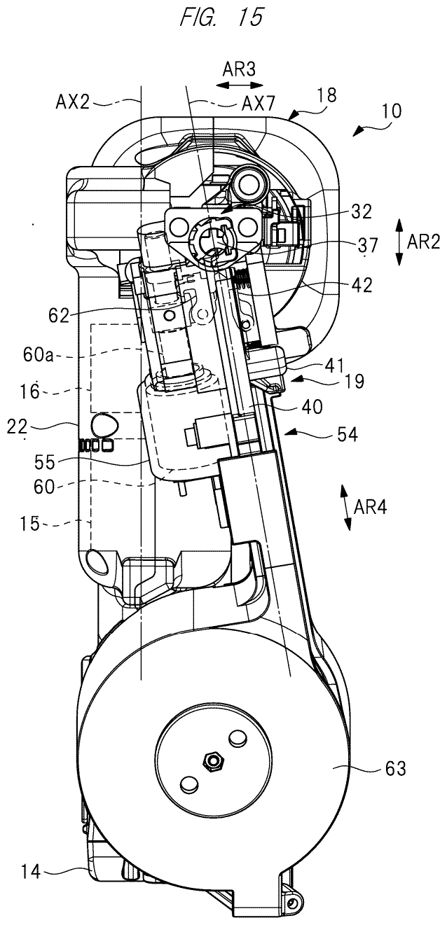

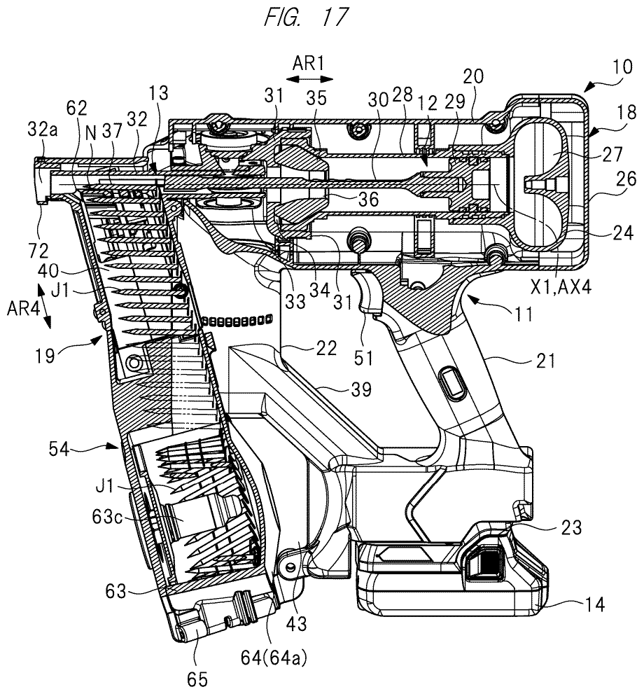

(Second Embodiment) FIG. 10 is a right external view of a working machine 10 according to a second embodiment, FIG. 11 is a top external view of the working machine 10, FIG. 12 is a front external view of the working machine 10, FIG. 13 is a left external view of the working machine 10, FIG. 14 is a rear external view of the working machine 10, and FIG. 15 is a bottom external view of the working machine 10. In the second embodiment, as well as in the first embodiment, the working machine 10 is, for example, an electric nailing machine. As illustrated in FIG. 10, the working machine 10 includes a housing 11, a striking mechanism 12, a nose unit 13, a power supply unit 14, an electric motor 15, a gear case 16, a conversion mechanism 17, a pressure accumulation container 18, a supply mechanism 19, and a magazine 54. As illustrated in FIGS. 14 and 15, the magazine 54 includes a drum unit 63 having a substantially cylindrical shape. The conversion mechanism 17 illustrated in FIG. 10 is a winding unit that includes a pin wheel 46 illustrated in FIG. 12 and winds up a piston 29 and a driver blade 30 toward the other (upper) side in the up-down direction (first direction AR1) against the biasing force of a biasing unit (pressure chamber 27 illustrated in FIG. 17) by being rotated about a winding axis AX8 extending in a direction intersecting with the up-down direction (first direction AR1).

The position of the magazine 54 in the working machine 10 of the second embodiment will be described. In the working machine 10 of the second embodiment, as illustrated in FIG. 11, a handle 21 and the electric motor 15 are provided such that an axis AX1 of the handle 21 (hereinbelow, referred to also as a handle axis AX1) and a rotation axis AX2 of the electric motor 15 (hereinbelow, referred to also as a motor axis AX2) are parallel to each other.

In the working machine 10 of the second embodiment, as well as in the working machine 10 of the first embodiment, as illustrated in FIG. 14, the magazine 54 is provided at a position overlapping with the electric motor 15 as viewed in the direction of the rotation axis AX2 of the electric motor 15, that is, in the rear external view of the working machine 10. Specifically, the substantially cylindrical drum unit 63 included in the magazine 54 of the working machine 10 of the second embodiment is provided at a position overlapping with the electric motor 15 in the rear external view of the working machine 10 in FIG. 14.

Specifically, the drum unit 63 of the magazine 54 is arranged further on the rear side in the front-rear direction (second direction AR2) illustrated in FIG. 10 than the electric motor 15 (on the side opposite to an ejection unit 32 relative to the electric motor 15 in the second direction AR2), so that the position of the drum unit 63 of the magazine 54 in the up-down direction (first direction AR1) is raised to a position substantially at the same height as the electric motor 15. Therefore, in the rear external view of the working machine 10 in FIG. 14, the drum unit 63 of the magazine 54 is arranged at a position overlapping with the electric motor 15, and the drum unit 63 of the magazine 54 is provided at a high position such that the motor axis AX2 passes through the vicinity of the central portion of the drum unit 63 of the magazine 54 in the up-down direction (first direction AR1). That is, the magazine 54 is arranged on the motor axis AX2, and the drum unit 63 of the magazine 54 is also arranged on the motor axis AX2.

Further, by moving the position of the drum unit 63 of the magazine 54 further on the rear side of the electric motor 15 than in the working machine 10 of the first embodiment, the distance of the magazine 54 from the electric motor 15 in the right-left direction (third direction AR3) can be minimized. This leads to a positional relationship in which the motor axis AX2 passes through the vicinity of the central portion of the drum unit 63 of the magazine 54 in the right-left direction (third direction AR3).

Therefore, in the working machine 10 of the second embodiment, the drum unit 63 of the magazine 54 is arranged further on the rear side than in the working machine 10 of the first embodiment, so that the drum unit 63 is arranged at a higher position. As a result, in the rear external view of the working machine 10, a positional relationship in which the motor axis AX2 passes through the vicinity of the central portion of the drum unit 63 of the magazine 54 in the up-down direction (first direction AR1) is established.

In other words, the magazine 54 is arranged on the winding axis AX8 as illustrated in FIG. 12. In the working machine 10 of the second embodiment, the case where the motor axis AX2 and the winding axis AX8 are coaxial has been described, but the motor axis AX2 and the winding axis AX8 are not necessarily coaxial and may be shifted from each other. However, even in a case where the motor axis AX2 and the winding axis AX8 are shifted, the magazine 54 is arranged on the winding axis AX8.

In addition, when a worker grips the working machine 10 to perform the nailing work, the worker himself/herself exists on the rear side of the working machine 10. Therefore, appropriate protrusion of the magazine 54 to the rear side of the working machine 10 does not particularly cause a problem for the nailing work.

As described above, in the working machine 10 of the second embodiment, the magazine 54 is arranged such that the motor axis AX2 passes through the vicinity of the center portion of the drum unit 63 of the magazine 54 in the up-down direction (first direction AR1), so that a distance L1 from the center of the pin wheel 46 (motor axis AX2) to the lower end (ejection port 32a) of the ejection unit 32 can be shortened as illustrated in FIG. 12.

That is, in the working machine 10 of the second embodiment, by arranging the magazine 54 to be shifted on the upper side, the supply mechanism 19 including the magazine 54 illustrated in FIG. 10 is also arranged to be shifted to the upper side. As a result, the distance L1 from the center of the pin wheel 46 (motor axis AX2) to the lower end (ejection port 32a) of the ejection unit 32 can be shortened, and the height of the working machine 10 can be reduced.

Next, the supply mechanism 19 coupled with the magazine 54 will be described. As illustrated in FIGS. 10 and 13, the working machine 10 includes a feeder unit 62 that feeds a nail N (see FIG. 17) from the magazine 54 to the ejection unit 32 along a supply axis AX7. The supply axis AX7 is an axis for supplying the nail N stored in the drum unit 63 from the drum unit 63 to the ejection unit 32. That is, the nail N pulled out from the drum unit 63 of the magazine 54 is sent along the supply axis AX7 to the ejection unit 32 by the supply mechanism 19 (see FIG. 17). As illustrated in FIGS. 11 and 15, the supply axis AX7 is inclined with respect to the motor axis AX2 as viewed in the up-down direction (first direction AR1). Therefore, the drum unit 63 of the magazine 54 is slightly shifted from the handle axis AX1 in the right-left direction (third direction AR3) illustrated in FIG. 11, and as a result, the electric motor 15 and the drum unit 63 do not interfere in the right-left direction (third direction AR3).

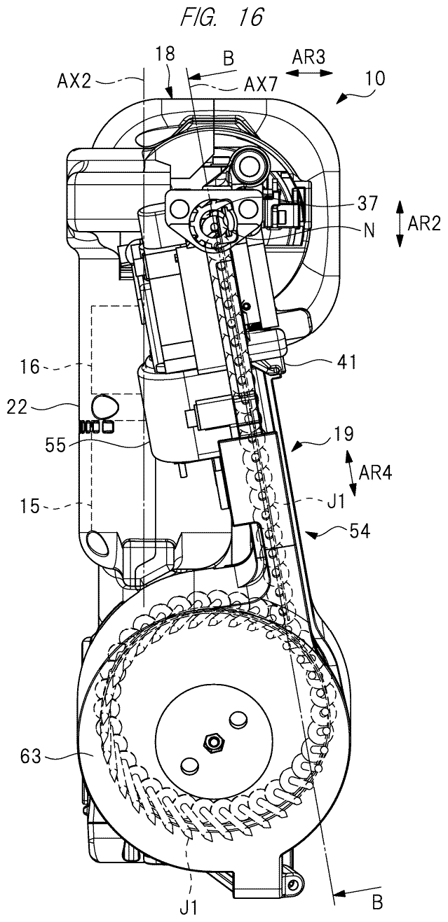

Here, FIG. 16 is a bottom external view illustrating a nail loading state of the working machine 10 and FIG. 17 is a cross-sectional view taken along line B-B in FIG. 16. As illustrated in FIGS. 13, 15, 16, and 17, the working machine 10 includes a cylinder 28 that movably houses the piston 29 and the driver blade 30 serving as striking units, and the supply mechanism 19 includes a solenoid 60 that drives the feeder unit 62. The coil included in the solenoid 60 is connected to the power supply unit 14, and generates a magnetic attraction force when current is supplied by the power supply unit 14. Due to this magnetic attraction force, the feeder unit 62 moves to a predetermined position (nail attachment position) on the rear side in a fourth direction AR4 along the supply axis AX7.

Then, when the current supply by the power supply unit 14 is terminated, the coil eliminates the magnetic attraction force. Hence, the feeder unit 62 moves from the nail attachment position to the front side in the fourth direction AR4, and the nail N is supplied to the ejection unit 32 on the front side in the fourth direction AR4 by the movement of the feeder unit 62. As a result, the feeder unit 62 positions the nail N, which is located at the head of a connecting element among the nails N housed in the drum unit 63 of the magazine 54, to the lower side of the driver blade 30.

Also, as illustrated in FIG. 13, the supply mechanism 19 includes a blade guide 40 and a nail guide 41 that guide the nail N (see FIG. 16) stored in the drum unit 63 to the ejection unit 32, and a nail stopper 42 that positions the nail N. As illustrated in FIG. 15, the solenoid 60 is provided on a solenoid output shaft 60a and is covered with a solenoid cover (cover unit) 55.

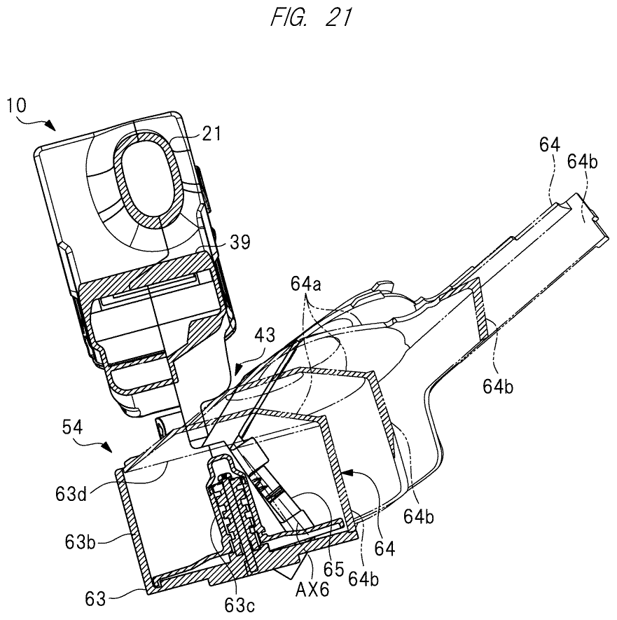

As illustrated in FIGS. 16 and 17, connected nails J1 wound in a roll shape are housed in the drum unit 63. An upper surface 63d and a side surface 63b of the drum unit 63 are covered with a magazine cover 64 (see FIG. 21). Then, in the supply mechanism 19, the connected nails J1 in a connected state are pulled out from the drum unit 63, and the connected nails J1 maintained in the connected state are sequentially fed along the supply axis AX7 toward the front side by the feeder unit 62, and the nails N are arranged one by one in an ejection path 37.

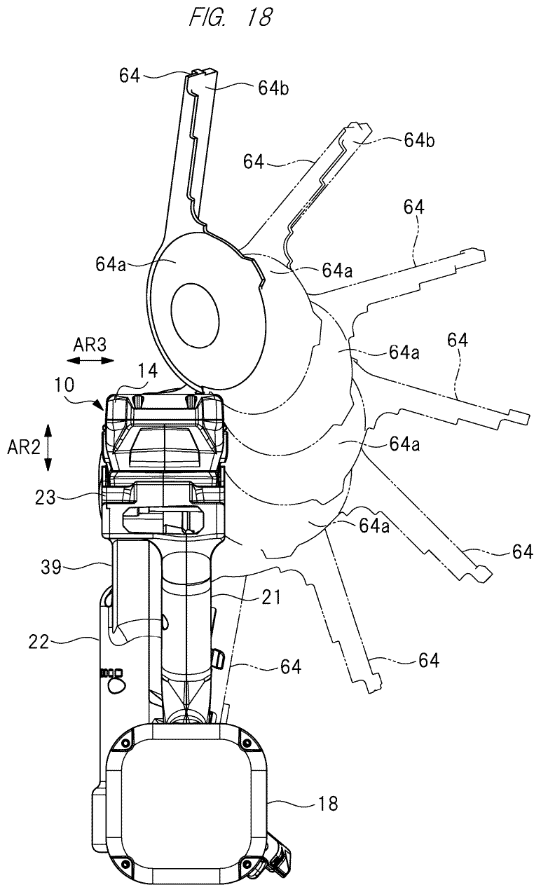

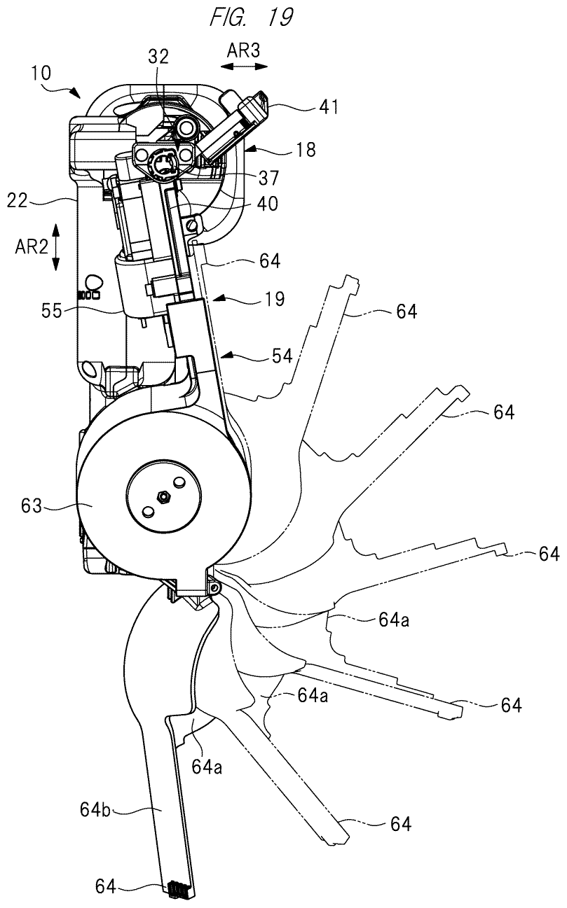

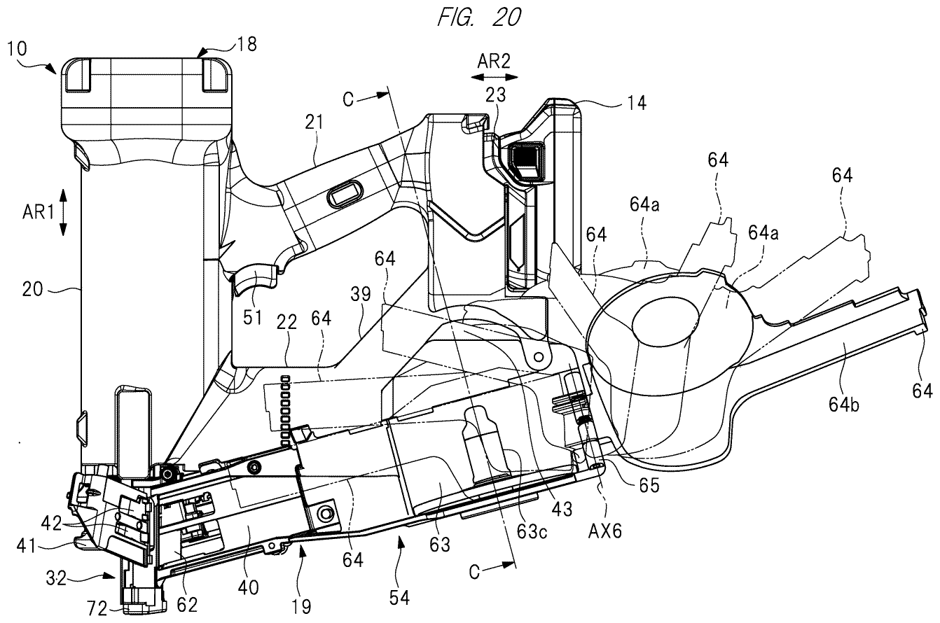

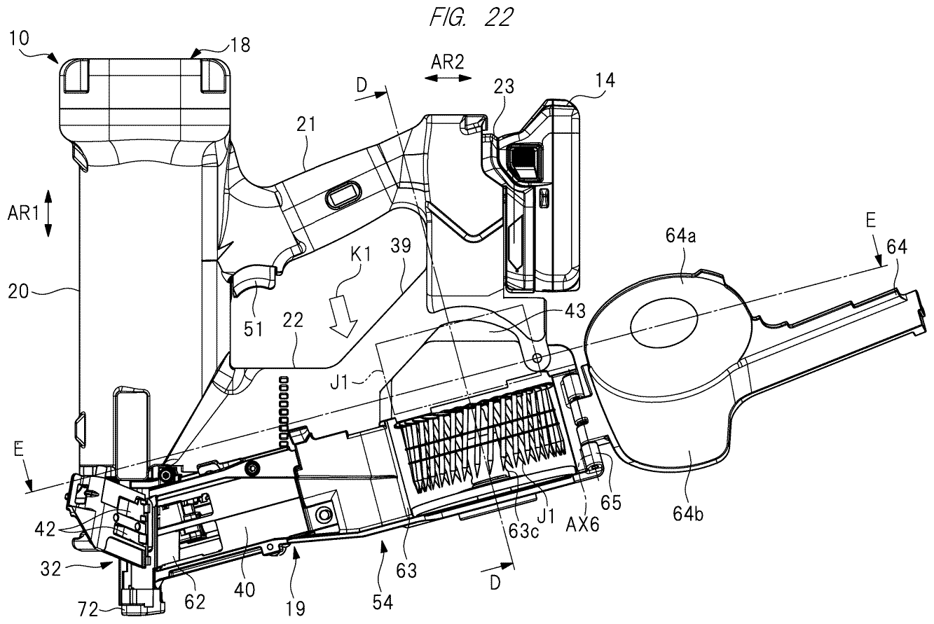

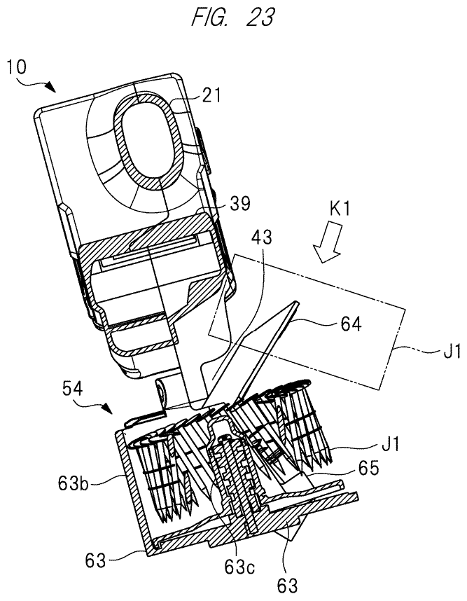

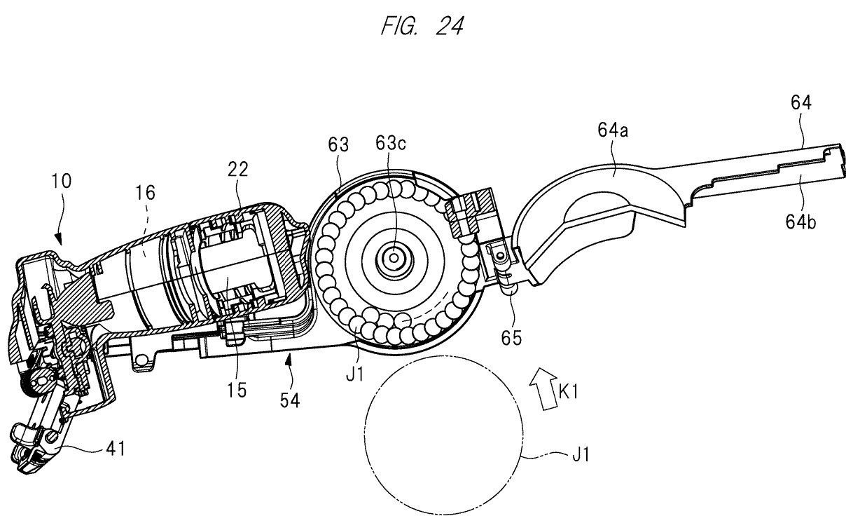

Next, a method of loading the connected nails J1 in the drum unit 63 of the magazine 54 will be described. FIG. 18 is a top external view illustrating a method for opening the magazine cover, FIG. 19 is a bottom external view illustrating the method for opening the magazine cover, and FIG. 20 is a left external view illustrating the method for opening the magazine cover. Also, FIG. 21 is a cross-sectional view taken along line C-C in FIG. 20, FIG. 22 is a left external view illustrating the nail loading method of the working machine 10 in FIG. 15, FIG. 23 is a cross-sectional view taken along line D-D in FIG. 22, and FIG. 24 is a cross-sectional view taken along line E-E in FIG. 22.

As illustrated in FIG. 16, the drum unit 63 can house the connected nails J1 wound in a roll shape. As illustrated in FIGS. 18 to 21, in the magazine 54, the upper surface 63d and the side surface 63b of the drum unit 63 are opened by rotating the magazine cover 64. Specifically, as illustrated in FIG. 21, the magazine cover 64 is formed to have an L shape, and thus can cover the upper surface 63d and the side surface 63b of the drum unit 63. In addition, a rotation axis AX6 for rotating the magazine cover 64 is inclined with respect to an axis AX5 of the drum unit 63 (see FIG. 14). Further, as illustrated in FIG. 10, a coupling unit 39 is provided at a portion that couples a battery attachment unit 23 of the power supply unit 14 with a motor case 22, and a space 43 is formed between the coupling unit 39 and the magazine cover 64 of the drum unit 63.

Therefore, as illustrated in FIGS. 18 to 20, when the magazine cover 64 is rotated about the rotation axis AX6, the magazine cover 64 rotates about the rotation axis AX6 while being opened obliquely upward in the space 43. As a result, as illustrated in FIGS. 21 to 24, the upper surface 63d and the side surface 63b of the drum unit 63 can be opened widely. Then, the connected nails J1 wound in a roll shape are loaded in a loading direction K1 from the obliquely upward side into the drum unit 63 whose upper surface 63d and side surface 63b are opened widely. At this time, as illustrated in FIG. 21, a rotation shaft 63c is provided in the drum unit 63 such that the connected nails J1 wound in a roll shape can be sequentially fed. Therefore, it is necessary to load the roll-shaped connected nails J1 on the drum unit 63 from above such that the center portion of the roll-shaped connected nails J1 is fitted to the rotation shaft 63c.

Therefore, in the working machine 10 of the second embodiment, as illustrated in FIG. 23, the space 43 is formed between the coupling unit 39 and the drum unit 63, and the coupling unit 39 has a housing shape so as not to interfere with the roll-shaped connected nails JI at the time of loading.

As described above, since the coupling unit 39 of the working machine 10 has such a housing shape so as not to interfere with the roll-shaped connected nails J1 when roading the connected nails J1, the roll-shaped connected nails J1 can be loaded into the drum unit 63 even in the working machine 10 of the second embodiment having the structure in which the magazine 54 is shifted on the upper side.

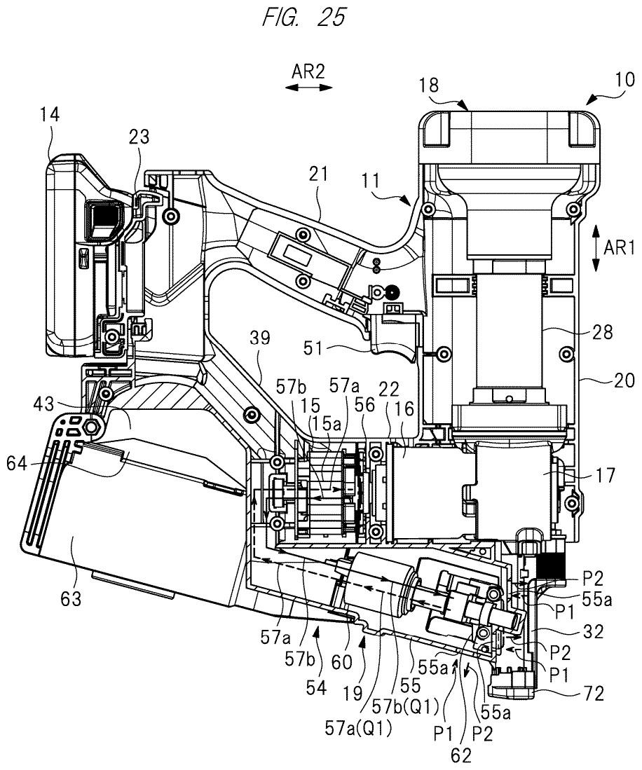

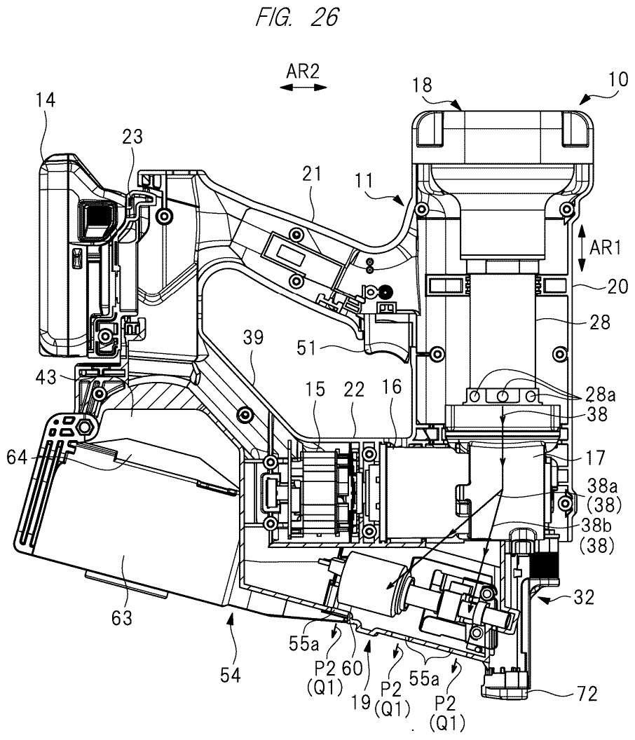

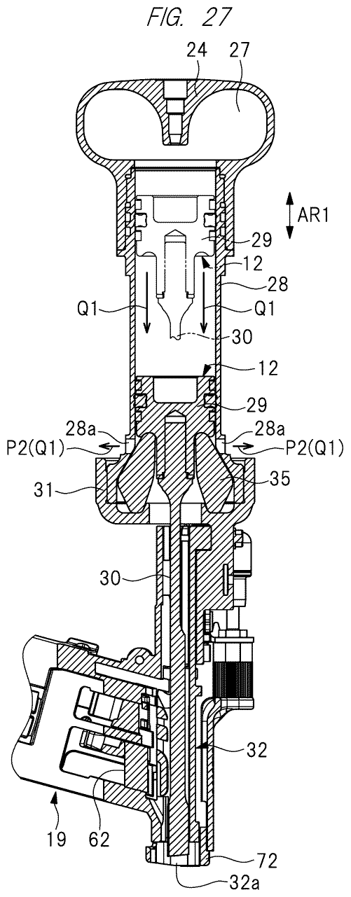

Next, cooling of the solenoid 60 included in the working machine 10 will be described. FIG. 25 is an internal cross-sectional view illustrating an air feeding path for air supplied from a fan to the solenoid of the working machine 10, FIG. 26 is an internal cross-sectional view illustrating an air feeding path for air exhausted from an air exhaust port of a cylinder to the solenoid of the working machine 10, and FIG. 27 is a cross-sectional view illustrating an air exhaust state inside the cylinder of the working machine 10.

As illustrated in FIGS. 26 and 27, the working machine 10 of the second embodiment includes the cylinder 28 having an air exhaust port 28a. A plurality of air exhaust ports 28a are provided at the lower portion of the outer periphery of the tubular cylinder 28. The working machine 10 includes an air feeding path 38 that feeds air Q1 exhausted from the air exhaust port 28a of the cylinder 28 toward the solenoid 60 by the downward movement of the piston 29 and the driver blade 30 serving as striking units. The air feeding path 38 is formed in the solenoid cover (cover unit) 55 that houses the solenoid 60.

Specifically, a cylinder case 20 in which the cylinder 28 is housed and the motor case 22 in which the electric motor 15 is housed are connected, and the motor case 22 and the solenoid cover 55 are connected. Also, the air feeding path 38 serving as a path for the air Q1 is provided from the cylinder case 20 to the solenoid cover 55 via the motor case 22. Further, a plurality of air exhaust ports 55a that exhaust the air Q1 are formed at the lower portion of the solenoid cover 55.

Therefore, as illustrated in FIG. 27, when the piston 29 and the driver blade 30 move to the lower side in the up-down direction (first direction AR1), the air Q1 existing below the piston 29 in the cylinder 28 is exhausted from the air exhaust port 28a of the cylinder 28. As illustrated in FIG. 26, the air Q1 exhausted from the air exhaust port 28a reaches the air feeding path 38 in the solenoid cover 55 through the air feeding path 38 provided in the cylinder case 20 and the motor case 22. Then, the air Q1 that has reached the air feeding path 38 in the solenoid cover 55 is fed to the plurality of air exhaust ports 55a provided at the lower portion of the solenoid cover 55 through an air feeding path 38a and an air feeding path 38b. At this time, the air Q1 is applied to the solenoid 60 provided in the solenoid cover 55, whereby the solenoid 60 can be cooled. Thereafter, the fed air Q1 is exhausted as exhaust air P2 from each air exhaust port 55a to the outside of the solenoid cover 55.

As described above, in the working machine 10 of the second embodiment, the air Q1 exhausted from the cylinder 28 by the downward movement of the piston 29 and the driver blade 30 is used, and the solenoid 60 can be cooled by applying the air Q1 to the solenoid 60. In addition, dust is generated at the time of nailing. Thus, by applying the air Q1 exhausted from the cylinder 28 to the solenoid 60 and the feeder unit 62, it is possible to reduce adhesion of dust generated at the time of nailing to the solenoid 60 and the feeder unit 62.

As illustrated in FIG. 25, a fan 56 is provided at a rotation shaft 15a of the electric motor 15. The fan 56 is rotated by the driving force of the electric motor 15. The fan 56 is, for example, a centrifugal fan, and the solenoid 60 and the feeder unit 62 are provided on air paths 57a and 57b of the fan 56.

Specifically, when the fan 56 rotates by the rotation of the rotation shaft 15a of the electric motor 15, the air Q1 is taken in as intake air P1 from the outside of the solenoid cover 55. The taken air Q1 hits the solenoid 60 and the feeder unit 62 and reaches the fan 56. The air Q1 taken into the fan 56 changes its direction and is exhausted from the fan 56. Further, the air Q1 exhausted from the fan 56 hits the solenoid 60 and the feeder unit 62, and then is exhausted to the outside of the solenoid cover 55 as the exhaust air P2.

Therefore, the solenoid 60 can be cooled by applying the air Q1 taken in by the rotation of the fan 56 to the solenoid 60. Further, by applying the air Q1 taken in by the rotation of the fan 56 to the solenoid 60 and the feeder unit 62, it is possible to reduce adhesion of dust generated at the time of nailing to the solenoid 60 and the feeder unit 62.

In the working machine 10 of the second embodiment, the drum unit 63 of the magazine 54 is arranged to be shifted to the rear side and to be shifted to the upper side, so that the size of the working machine 10 can be reduced while reducing interference between the electric motor 15 and the magazine 54. At this time, the supply mechanism 19 including the magazine 54 is also arranged to be shifted to the upper side. Therefore, the distance L1 (see FIG. 12) from the center of the pin wheel 46 (motor axis AX2) to the lower end of the ejection unit 32 (ejection port 32a) can be shortened, and the height of the working machine 10 can be reduced. As a result, the size of the working machine 10 can be reduced.

Since the size of the working machine 10 can be reduced, degradation of operability and workability of the working machine 10 can be reduced, and usability of the working machine 10 can be improved.

When the nailing work is to be performed using the nailing machine in a place having a short height, the head of the worker may hit the wall or the like. Therefore, as in the working machine 10 of the second embodiment, reducing the height of the working machine 10 to reduce the size of the working machine 10 is effective in facilitating the nailing work of the worker.

The present invention is not limited to the above embodiments, and various modifications can be made within the range not departing from the gist of the present invention. That is, other embodiments conceivable within the scope of the technical concept of the present invention are also included in the scope of the present invention.

### Reference Signs List

10 Working machine
11 Housing
Striking mechanism
13 Nose unit
14 Power supply unit
15 Electric motor (motor)
15a Rotation shaft
16 Gear case
17 Conversion mechanism (winding unit)
18 Pressure accumulation container
19 Supply mechanism
20 Cylinder case
21 Handle
22 Motor case
22a Recess
22b Wall surface
22c Virtual circle
23 Battery attachment unit
24 Cap
26 Head cover
27 Pressure chamber (biasing unit)
28 Cylinder
28a Air exhaust port
29 Piston (striking unit)
30 Driver blade (striking unit)
31 Bumper support unit
32 Ejection unit
32a Ejection port
33 Tubular unit
34 Guide hole
35 Bumper
36 Guide hole
37 Ejection path
38, 38a, 38b Air feeding path
39 Coupling unit
40 Blade guide
41 Nail guide
42 Nail stopper
43 Space
45 Drive shaft
46 Pin wheel
47 Rack
48 Pinion pin
51 Trigger
54 Magazine
55 Solenoid cover (cover unit)
55a Air exhaust port
56 Fan
57a, 57b Air path
59 Spring
60 Solenoid
60a Solenoid output shaft
61 Iron core
62 Feeder unit
63 Drum unit
63a Bottom surface
63b Side surface
63c Rotation shaft
63d Upper surface
64 Magazine cover
64a Upper surface
64b Side surface
65 Coupling mechanism
72 Push lever
AR1 First direction (up-down direction)
AR2 Second direction (front-rear direction)
AR3 Third direction (right-left direction)
AR4 Fourth direction
AR5 Protruding direction
X1 First center line
AX1 Axis
AX2 Rotation axis
AX3 Center axis
AX4 Striking axis
AX5 Axis
AX6 Rotation shaft
AX7 Supply axis
AX8 Winding axis
D1, D2 Outside diameter
G1 Overlapping portion
J1 Connected nails
K1 Loading direction
L1 Distance
N Nail (fastener)
P1 Intake air
P2 Exhaust air
Q1 Air

1-20. (canceled)

21. A working machine comprising:
a magazine that includes a drum unit having a substantially cylindrical shape and houses a plurality of fasteners wound in a spiral shape inside;
an ejection unit to which the fastener is supplied;
a striking unit that moves to one side in a first direction to strike the fastener supplied to the ejection unit;
a biasing unit that biases the striking unit toward the one side in the first direction;
a winding unit that winds up the striking unit toward the other side in the first direction against a biasing force of the biasing unit;
a motor that generates a driving force for driving the winding unit;
a handle that is gripped by a worker;
a motor case that houses the motor;
a feeder unit that feeds the fastener from the magazine to the ejection unit along a supply axis; and
a solenoid that drives the feeder unit,
wherein a motor axis which is a rotation axis of the motor extends in a direction intersecting with the first direction,
wherein the drum unit is arranged at a position overlapping with the motor case as viewed in a direction of the motor axis,
wherein the solenoid is arranged on the one side in the first direction with respect to the motor case, and
wherein the motor case and the solenoid overlap as viewed in the first direction.

22. The working machine according to claim 21, wherein the magazine is arranged on the motor axis.

23. The working machine according to claim 21, comprising
a cover unit that houses the solenoid,
wherein an inside of the cover unit and an inside of the motor case are connected.

24. The working machine according to claim 21, wherein the drum unit overlaps with the solenoid as viewed in a direction of the supply axis.

25. The working machine according to claim 21, wherein the motor case is arranged between the solenoid and the handle.

26. The working machine according to claim 22, wherein the supply axis is inclined with respect to the motor axis as viewed in the first direction.

27. The working machine according to claim 23, comprising a cylinder that movably houses the striking unit,
wherein an air feeding path that feeds air exhausted from an exhaust port of the cylinder by a movement of the striking unit toward the solenoid is provided.

28. The working machine according to claim 27, wherein the air feeding path is formed in the cover unit.

29. The working machine according to claim 21, comprising a fan that is rotated by the driving force of the motor,
wherein the solenoid is provided on an air path of the fan.

30. The working machine according to claim 21,
wherein a handle axis which is an axis of the handle extends in a direction intersecting with the first direction,
wherein the handle axis is inclined with respect to the motor axis as viewed in the first direction.

31. The working machine according to claim 30, wherein a magazine axis which is an axis of the magazine is inclined with respect to a striking axis of the striking unit extending in the first direction as viewed in a second direction along the handle axis.

32. The working machine according to claim 31,
wherein the magazine is arranged on one side in the first direction with respect to the handle and the motor, and the magazine axis is inclined toward the motor axis on the other side in the first direction, and
wherein the motor is arranged on one side in a third direction intersecting with the first direction and the second direction with respect to the handle, and the motor axis is inclined toward the handle axis on one side in the second direction.

33. The working machine according to claim 32, further comprising a battery attachment unit that is arranged at an end of the handle on the other side in the second direction and to which a battery is detachably attached,
wherein a center axis of the battery attachment unit is arranged to be shifted to the one side in the third direction with respect to the handle axis as viewed in the first direction.

34. The working machine according to claim 33, wherein the center axis of the battery attachment unit is parallel to the handle axis.

35. The working machine according to claim 21, further comprising a battery attachment unit to which a battery is detachably attached,
wherein a center axis of the battery attachment unit is parallel to the motor axis.

36. The working machine according to claim 21,
wherein the magazine includes a housing unit that houses the fastener and a magazine cover that covers a part of the housing unit, and
wherein the motor case is provided with a recess for avoiding interference with the magazine cover.

37 The working machine according to claim 21,
wherein the magazine includes a housing unit that houses the fastener and a magazine cover that covers a part of the housing unit, and
wherein the magazine cover is provided with a recess for avoiding interference with the motor case.

38. A working machine comprising:
a magazine that includes a drum unit having a substantially cylindrical shape and houses a plurality of fasteners wound in a spiral shape inside;
an ejection unit to which the fastener is supplied;
a striking unit that moves to one side in a first direction to strike the fastener supplied to the ejection unit;
a biasing unit that biases the striking unit toward the one side in the first direction;
a winding unit that winds up the striking unit toward the other side in the first direction against a biasing force of the biasing unit;
a motor that generates a driving force for driving the winding unit;
a handle that is arranged on the other side in the first direction with respect to the motor and extends along a second direction intersecting with the first direction;
a feeder unit that is arranged on the one side in the first direction with resect to the motor and feeds the fastener from the magazine to the ejection unit along a supply axis; and
a solenoid that drives the feeder unit,
wherein a motor axis which is a rotation axis of the motor extends in a direction intersecting with the first direction,
wherein a handle axis which is an axis of the handle extends in the direction intersecting with the first direction,
wherein the handle axis is inclined with respect to the motor axis toward the other side in the first direction as approaching one side in the second direction, and
wherein the supply axis is inclined with respect to the motor axis toward one side in the first direction as approaching the one side in the second direction.

39. A working machine comprising:
a magazine that includes a drum unit having a substantially cylindrical shape and houses a plurality of fasteners wound in a spiral shape inside;
an ejection unit to which the fastener is supplied;
a striking unit that moves to one side in a first direction to strike the fastener supplied to the ejection unit;
a biasing unit that biases the striking unit toward the one side in the first direction;
a winding unit that winds up the striking unit toward the other side in the first direction against a biasing force of the biasing unit;
a motor that generates a driving force for driving the winding unit; and
a handle that is gripped by a worker,
wherein the handle extends in a second direction intersecting with the first direction,
wherein a motor axis which is a rotation axis of the motor extends in a direction intersecting with the first direction,
wherein the drum unit is arranged at a position overlapping with a motor case as viewed in a direction of the motor axis, and
wherein a magazine axis which is an axis of the drum unit is inclined with respect to a striking axis of the striking unit extending in the first direction as viewed in the second direction.
